(19) United States
(12) Patent Application Publication
(10) Pub. No.: US 2002/0055887 A1
(43) Pub. Date: May 9, 2002

(54) Method of providing a global exchange in an electronic commerce environment

(76) Inventor: Michael J. Seguin, Eden, UT (US)

Correspondence Address: Berne S. Broadbent, KIRTON & McCONKIE, Suite 1800, 60 East South Temple, Salt Lake City, UT, 84111, US

(21) Appl. No.: 09/987,802

(22) Filed: Nov. 9, 2001

Related U.S. Application Data
(60) Provisional application No. 60/247,446, filed on Nov. 9, 2000.

(51) Int. Cl. G06F 17/60

(52) U.S. Cl. 705/26

(57) ABSTRACT

Systems and methods for providing a dynamically customizable commerce portal for the purchasing of goods and/or services that are offered for sale by a variety of vendors. The disclosure describes in part a commerce portal, wherein the portal includes a customizable selection of products offered for sale by a variety of vendors. A first computer device is configured to provide information for the commerce portal. A second computer device is configured to selectively access the commerce portal to procure products provided in the commerce portal. The first and second computer devices are connected to a network. Purchasing information that represents products provided in the portal is transmitted by the second computer to the commerce portal. The portal includes a customizable selection of products offered for sale by virtually any vendor.

### RELATED APPLICATIONS

This application claims priority to U.S. Provisional Patent Application Ser. No. 60/247,446 filed Nov. 9, 2000, entitled METHOD OF PROVIDING A GLOBAL EXCHANGE IN AN ELECTRONIC COMMERCE ENVIRONMENT, which is incorporated herein by reference.

### BACKGROUND OF THE INVENTION

1. Field of the Invention

The present invention relates to electronic commerce. In particular, the present invention relates to systems and methods for providing a dynamically customizable commerce portal for the purchasing of goods and/or services that are offered for sale by a variety of vendors.

2. Background and Related Art

As with many types of businesses, medical clinics are required to purchase products and supplies to support the services they offer. These products and supplies come from specialized manufacturers and companies at locations often far removed from the clinic. A great deal of time and effort can be spent trying to procure and maintain an appropriate inventory of products and supplies to maintain the clinic's services.

Traditional methods for purchasing clinical supplies include visiting “brick and mortar” establishments where some of the medical supplies can be obtained. Additionally, a manger or a clinic may place sales orders with a vendor, which are transmitted by fax or through the mail to the vendor who receives and fills the order and then presents the clinic with a bill. In some instances the purchasing will take place through an intermediate distributor. In some cases, the vendor may have established a business web site allowing the manager of a clinic to visit the web site and order products online. The clinic may pay at the time of ordering or may be billed later by the vendor.

The time and effort it takes to obtain the materials through traditional methods of purchasing, together with the expense of the products themselves can add significantly to the cost of maintaining a clinic as when a manager of a dialysis clinic attempts to purchase goods using traditional methods. In order to purchase drugs, the dialysis clinic manager may attempt to purchase drugs through an online distribution channel established by the drug manufacturer. The dialysis clinic manager using a computer connected to the internet, gains access to the website of pharmaceutical company A and purchases a drug from pharmaceutical company A. The clinic manager then accesses a website of pharmaceutical company B and purchases other drugs from pharmaceutical company B. In order to obtain bloodlines and needles for the dialysis clinic, the manager may then submit a paper purchase order to the company that supplies the clinic with bloodlines and needles. After mailing the paper purchase order, the clinic manager may have to leave the clinic and personally visit a distributor to purchase a hemodialysis machine for the clinic. Each of these transactions will require separate billing statements and accounting procedures. The bills are sent from the vendor to the clinic where the accounting department of the clinic will attempt to verify receipt of the goods and will settle the debt.

The example above reveals the types of problems faced by the manager of a healthcare clinic, such as a dialysis clinic. The size of the problem faced by a clinic manager is actually much larger than the example shown since the amount of purchasing done by the manager greatly exceeds what is shown in the example. The problem is compounded as the number of products and vendors increases. Additionally, if the clinic manager is able to negotiate a more favorable purchasing position with one of the vendors, it may be difficult to maintain and keep track of the different terms of the various purchasing arrangements.

### SUMMARY OF THE INVENTION

The present invention relates to electronic commerce. In particular, the present invention relates to systems and methods for providing a dynamically customizable commerce portal for the purchasing of goods and/or services that are offered for sale by a variety of vendors.

Implementation of the present invention takes place in association with a commerce portal that provides accessibility to a variety of vendors offering for sale various goods and/or services.

The present invention is directed to a system for providing a commerce portal on the internet that is used to procure products, such as goods and services, offered for sale by vendors. In a preferred embodiment, the commerce portal includes a customizable selection of products. The products offered can be customized by the vendor, who is able to change the products, pricing and other information relevant to the offer for sale of the vendors products. Likewise, the products selection can be customized by the customer buying the products, such as a customized purchase order, for convenience in selecting products and making purchases.

The system employs a first computer device configured to provide information for the commerce portal, such as a server, and a second computer device, such as a portable computer, configured to selectively access the commerce portal to procure products provided in the commerce portal. A network connects the first and second computers. In the preferred embodiment the Internet, a global computer network, is used to connect the computers and provide access to the portal.

A customer who wishes to purchase products using the portal transmits purchasing information about the products to the first computer by the second computer. The customer may also use the second computer to transmit or store purchasing information regarding purchases that do not use the portal. A third computer device tracks the purchasing of products from the portal by the customer.

Using the present invention, as described provides customers and vendors with a commerce portal that may be used in the procurement of virtually any product from any vendors. The portal receives purchasing information, such as a purchase order, from a customer that indicates which products provided in the commerce portal the customer wishes to purchase. The purchasing information is then distributed to one or more vendors corresponding to the products purchased. The transaction is monitored and customers can track the purchase. Monitoring and tracking are helpful for the customers, portal operators and vendors. For example, the monitoring may provide data for analysis and or allow purchases to be verified.

While the methods and processes of the present invention have proven to be particularly useful in the medical industry, and more particularly for the purchase of goods and/or services relating to dialysis procedures, those skilled in the art can appreciate that the methods and processes can be used in a variety of different applications and in a variety of different industries to yield a dynamically customizable commerce portal for the purchasing of goods and/or services that are offered for sale by a variety of vendors.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1;

FIG. 3 illustrates a flow chart that provides a representative embodiment for accessing and otherwise using a dynamically customizable commerce portal for the purchasing of goods and/or services that are offered for sale by a variety of vendors; and

FIG. 4 illustrates a flow chart that provides a representative embodiment for providing a dynamically customizable commerce portal for the purchasing of goods and/or services that are offered for sale by a variety of vendors.

### DETAILED DESCRIPTION OF THE INVENTION

The present invention relates to electronic commerce. In particular, the present invention relates to systems and methods for providing a dynamically customizable commerce portal for the purchasing of goods and/or services that are offered for sale by a variety of vendors.

Embodiment of the present invention takes place in association with a commerce portal that provides accessibility to a variety of vendors offering for sale various goods and/or services. In the disclosure and in the claims the term “vendor” shall refer to any entity that provides or otherwise offers for sale one or more goods and/or services. Examples of vendors include manufacturers, distributors, merchants, retailers, and the like.

The following disclosure of the present invention is grouped into two subheadings, namely “Exemplary Operating Environment” and “Providing and Using a Commerce Portal.” The utilization of the subheadings is for convenience of the reader only and is not to be construed as limiting in any sense.

### Exemplary Operating Environment

Embodiments of the present invention embrace the use of a computer device to receive and/or record orders through an electronic commerce portal that includes goods and/or services that are offered for sale by a variety of vendors. The orders may be placed by purchasers or representatives thereof via facsimile, electronic mail (“e-mail”), telephone, or the internet. All purchase orders are prepared through the electronic commerce portal, and may be selectively portioned and delivered electronically or by another method, as will be further explained below.

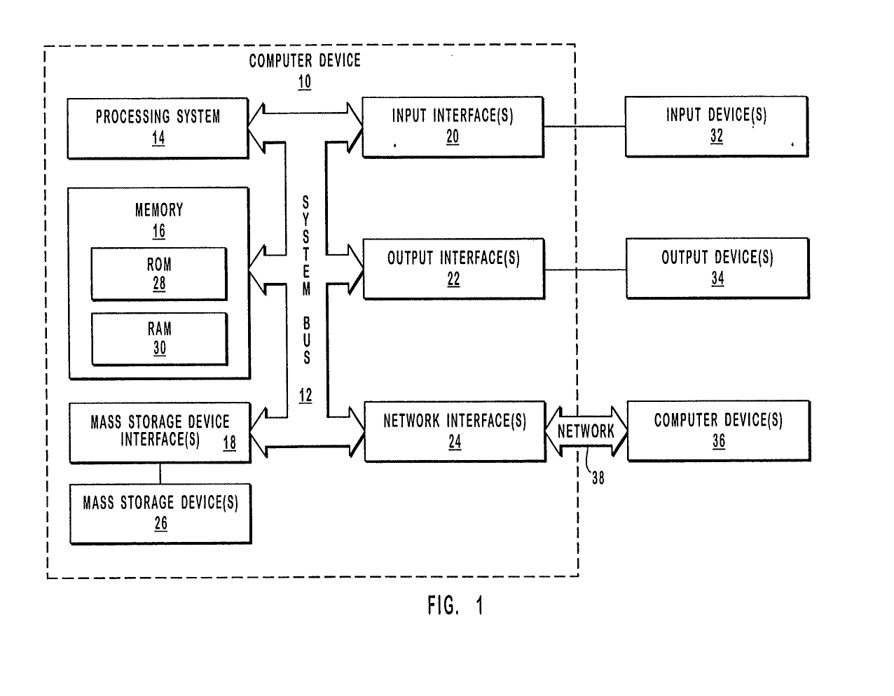

FIG. 1 and the corresponding discussion are intended to provide a general description of a computer device as a suitable operating environment to receive and/or record orders through a commerce portal. One skilled in the art will appreciate that the invention may be practiced by one or more computing devices and in a variety of system configurations, including in a networked configuration.

Embodiments of the present invention embrace one or more computer readable media that may be used to receive and/or record orders through a commerce portal, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for receiving and/or recording orders utilizing a commerce portal includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

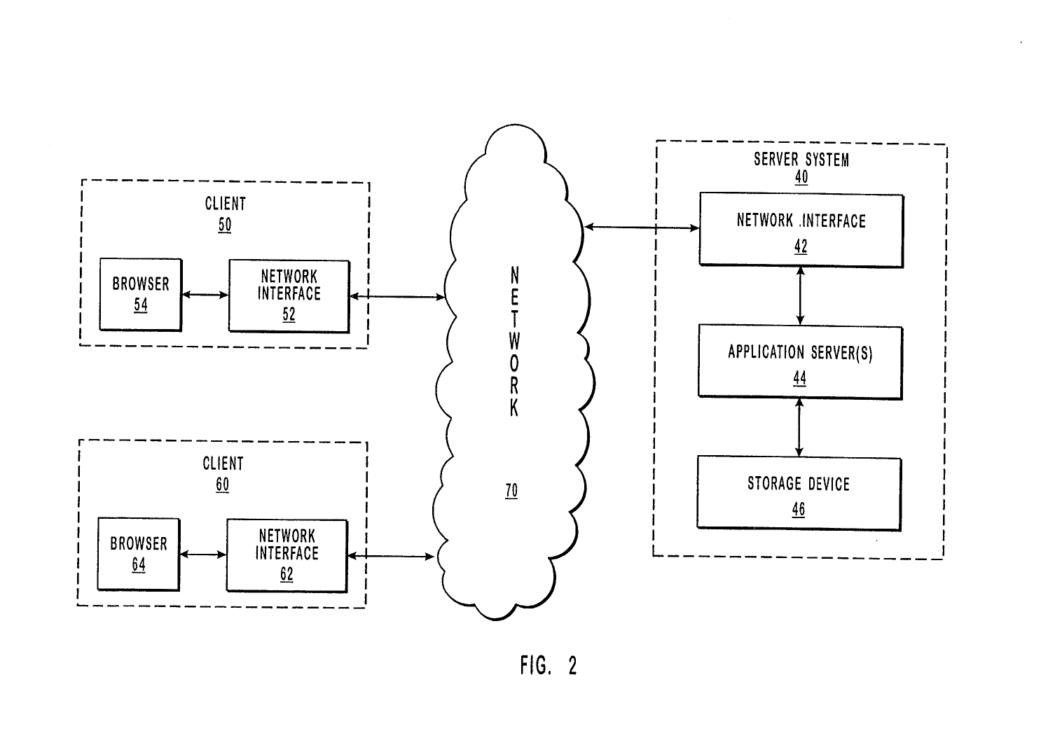

While those skilled in the art will appreciate that the invention may be practiced in networked computing environments with many types of computer system configurations, FIG. 2 represents an embodiment of the present invention that enables one or more client computer devices to be used to place orders utilizing a commerce portal. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

In FIG. 2, server system 40 represents a system configuration that includes one or more servers that are used to receive and/or record orders using a commerce portal. By way of example, server system 40 may be a single server in cases where a single server can process and preserve the entire amount of information required to perform the methods and systems of the present invention, as will be further explained below. Alternatively, server system 40 may be a conglomeration of servers that process and preserve a high volume of information.

In accordance with the present invention, a purchaser may record and/or submit an order for one or more goods and/or service through the use of a commerce portal. The orders may be placed via facsimile, electronic mail (“email”), telephone, or the Internet. When an order is placed by facsimile, telephone or via email, an agent, who enters or otherwise records the order into a computer device, may receive the order, and a copy of the order is preserved by server system 40. Alternatively, when an order is placed via email, the order may be sent from a computer device, across a network, to server system 40, which preserves an electronic copy of the order.

The emergence of the Internet has enabled a very large number of computer devices across the world to be connected across a wide area network in order to participate in global electronic commerce and enables the utilization of a common portal for the commerce. The following is a discussion of an embodiment of the present invention that includes a plurality of clients, illustrated as clients 50 and 60, that are connected to server system 40 across the Internet, illustrated as network 70, in order to receive and/or record orders through the utilization of a commerce portal.

With reference to FIG. 2, clients 50 and 60 each include a network interface (respectively illustrated as network interfaces 52 and 62) and a Web Browser (respectively illustrated as browsers 54 and 64). Network interface 52 is a communication mechanism that allows a client, such as client 50 to communicate to server system 40 by a network 70, such as the Internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a particular web page that is utilized as a single commerce portal, which provides various goods and/or services that are offered for sale by a variety of vendors.

Server system 40 includes network interface 42, application servers 44, and storage device 46. Network interface 42 is a communication mechanism that allows server system 40 to communicate with one or more clients by a network 70. Application servers 44 include one or more servers for processing and/or preserving information, and may be employed for providing and maintaining a web page that enables the ordering or recording of an order through the use of a commerce portal. Storage device 46 includes one or more storage devices for preserving information, such as transactional information and/or purchaser information to perform the methods enclosed herein. In one embodiment, storage device 46 further preserves information to authenticate use of the commerce portal, as will be further explained below. Storage device 46 may be internal or external to application servers 44.

Thus, a user at one of the clients, such as client 50, may access a web page maintained by one or more of the application servers 44 and electronically utilize a commerce portal for the purchasing of goods and/or services that are offered for sale by a variety of vendors. While the discussion above has presented a representative system configuration for implementing the present invention, those skilled in the art will appreciate that the methods of the present invention and processes thereof may be implemented in a variety of different system configurations.

### Providing and Using a Commerce Portal

As provided above, embodiment of the present invention takes place in association with a commerce portal that provides accessibility to a variety of vendors offering for sale various goods and/or services. In the disclosure and in the claims the term “vendor” shall refer to any entity that provides or otherwise offers for sale one or more goods and/or services. Examples of vendors include manufacturers, distributors, merchants, retailers, and the like.

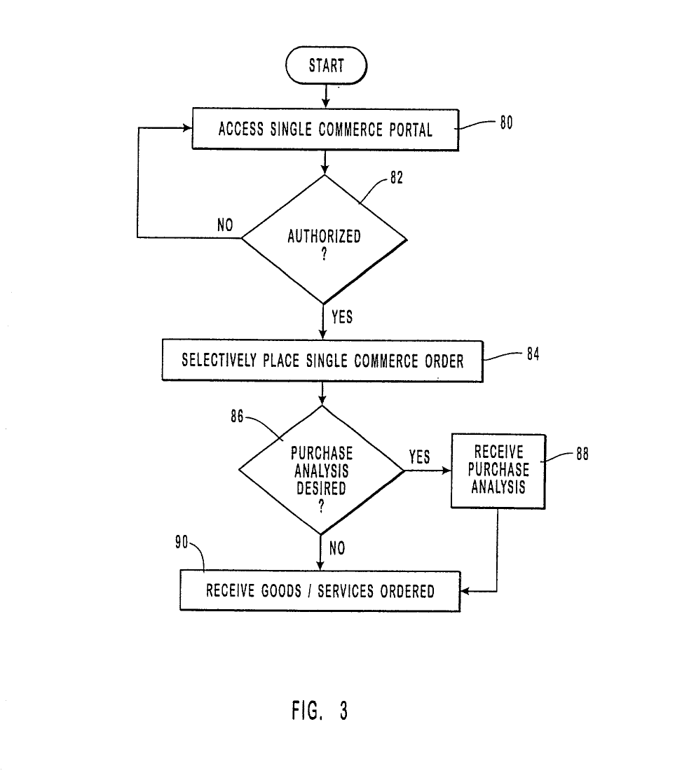

FIG. 3 illustrates a flow chart that provides a representative embodiment for accessing and otherwise using a dynamically customizable commerce portal for the purchasing of goods and/or services that are offered for sale by a variety of vendors. In FIG. 3, execution begins at step 80 where a user, or an agent thereof, accesses a single commerce portal. A determination is then made at decision block 82 as to whether or not the user is authorized for utilizing the commerce portal. If it is determined that the user is not authorized to use the commerce portal, execution returns back to start. Otherwise, if it is determined at decision block 82 that the user is authorized to utilize the commerce portal, execution proceeds to step 84.

At step 84, an order is selectably placed or recorded utilizing the commerce portal. Execution then proceeds to decision block 86 for determination as to whether or not a purchase analysis is desired. If it is determined at decision block 86 that a purchase analysis is desired, execution proceeds to step 88, where the purchase analysis is received at the client computer device and execution proceeds to step 90. Alternatively, if it is determined at decision block 86 that the purchase analysis is note desired, execution proceeds directly to step 90. At step 90, the user that placed the order utilizing the commerce portal receives the corresponding goods or services.

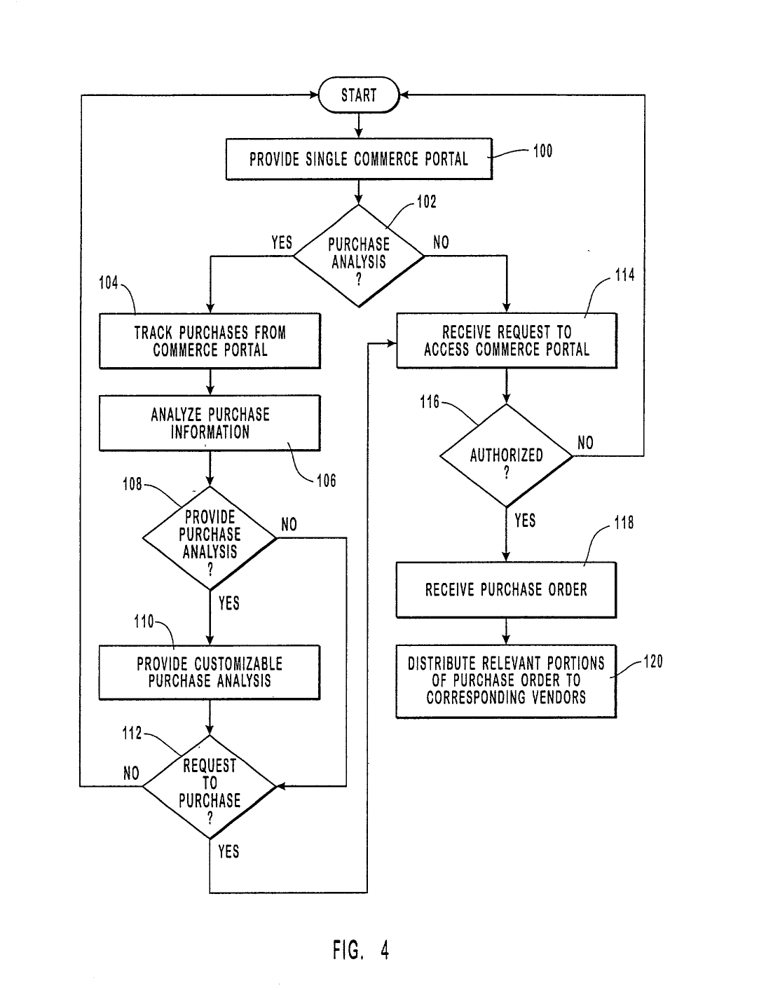

FIG. 4 illustrates a flow chart that provides a representative embodiment for providing a dynamically customizable commerce portal for the purchasing of goods and/or services that are offered for sale by a variety of vendors. In FIG. 4, execution begins at step 100 where a single commerce portal is provided. A determination is then made at decision block 102 as to whether or not a purchase analysis is desired. If it is determined at decision block 102 that purchase analysis is desired by a particular user, customer, or vendor, execution proceeds to step 104 for the tracking of purchases ordered or otherwise recorded through the use of the commerce portal. Execution then proceeds to step 106 where the purchase information that is being tracked is analyzed. At decision block 108, a determination is made as to whether or not to provide a purchase analysis to a particular user, customer, or vendor. If it is determined at decision block 108 that a purchase analysis is not to be provided, execution proceeds to decision block 112. Alternatively, if it is determined at decision block 108 that a purchase analysis is to be provided, execution proceeds to step 110 where a customizable purchase analysis is provided. At decision block 112, a determination is made as to whether or not a request has been received by the commerce portal. If it is determined at decision block 112 that no request has been received, execution returns back to start. Otherwise, execution proceeds to step 114.

If a determination is made that a purchase analysis is not to be provided or if it is determined at decision block 112 that a request has been received, then the request to access the commerce portals is received at step 114. A decision is then made at decision block 116 as to whether or not the user making the request is authorized. If the user is not authorized, execution returns back to start. Otherwise, execution proceeds to step 118, where the purchase order is received. At step 120, relevant portions of the purchase order are distributed to corresponding vendors of the commerce portal.

The present invention provides a complete online electronic commerce procurement system. The system allows procurement of virtually any materials whether or not the vendor of the material is electronically integrated into the system. The system maintains individualized contract pricing between vendors and buyers and facilitates the purchase of products through preferred vendors. Additionally, the system provides customizable periodic inventory management for certain users, such as dialysis centers.

In one embodiment, the system acts as an “electronic roundhouse” for electronic commerce in the dialysis industry allowing all the vendors in the industry to be integrated through a single commerce portal and all of the users in the industry to access those vendors through the same portal. This provides an environment of procurement standardization for the industry. A supplier can electronically integrate its vending business with its customers through a single portal rather than try to integrate with multiple clients in order to provide electronic commerce. The present system translates any technological differences in code or format allowing suppliers and purchasers to transact business freely. Similar advantages apply to the buyer. Using the single portal, the buyer does not have to manage electronic connections between multiple vendors. The system allows any customer to connect and purchase from any vendor through the portal.

In one example, an existing client of the commerce portal, a dialysis clinic, discovers a product that they wish to purchase. The dialysis clinic logs on to the database hosted by the commerce portal and logs into a standard purchasing order designed specifically for that clinic that lists precuts regularly purchased by the clinic. The clinic submits the product, vendor, part number, quantities, and other related information necessary for purchasing the product to the portal using the customized purchase order. Alternatively, the clinic can contact the customer service department of the portal over the telephone and instruct the portal operators to add the product to the clinic's purchase order. The purchase order now contains the new product and other products that are regularly purchased by the clinic. Once the purchase order is submitted by the clinic to the portal, the single purchase order is automatically separated into separate purchase orders and sent to the corresponding vendors, where the order is filled.

Alternatively, the client can create a completely separate purchase order, which will not be transmitted through the portal, but which can be sent electronically, by fax, or in paper form to the vendor. This “non-portal” purchase order remains integrated with the purchasing orders sent through the portal, allowing the clinic to maintain a completely integrated materials procurement database. The owner of the commerce portal may elect to charge transaction fee or collect a percentage of the sales as a commission.

The present invention operates as means to “outsource” a company's inventory procurement department. During the purchasing process, information is submitted to purchase the product and the information is processed by the commerce portal's servers. The order is confirmed and an electronic confirmation is sent to the interested parties. Finally, the product is received. After receipt of the product, the purchaser can then decide to what extent he wishes the system to regulate his receipts and inventory. He can go back into the system and create a receiving record that allows him to keep track of everything he bought and when it was received. He can also use his receiving record to facilitate the authorization of payment by matching up the information in the receiving record with the purchase order and the packing slip from the vendor (received with the product as delivered). That information can be forwarded to the accounting department and the accounting department is then authorized to pay the bill for the item purchased.

The present invention allows the client to not only purchase multiple products from multiple vendors at a single site, but also creates individual purchasing orders for each of the products purchased so that the products received from the various vendors can be tracked and accounted for. Inventory is matched and coordinated with the accounts payable. The application facilitates the ability of the accounts payable department to associate invoices with materials and products actually received in inventory. The “break-down” of the initial portal purchase order into individual purchase orders, which is done automatically through the software application that runs the commerce portal, makes this tracking possible.

When a new clinic becomes part of the system, a template purchase order is created for the clinic that includes favorite or regular purchases by a clinic. The template can be modified or customized according to the changing needs of the clinic. Additionally, a database with information regarding products available to the clinic that are not included on the template are available for searching by the clinic. The template allows the clinic to purchase a favorite or regular items on a periodic basis. Items that are purchased each week can be a part of the weekly template, and items purchased every month will be included on the template for the purchase order once a month as desired by the clinic. The system reduces the time and effort necessary to organize and carry out materials procurement. Some purchases can even be made automatically on a periodic basis, without the need for the user to log on. Importantly, however, this process of “automatic purchase” still creates separate purchase orders for each automatic periodic purchase, which allows the accounts payable department to maintain appropriate accounting records.

Certain parts of the application have been customized to work specifically with medical clinics, such as a dialysis clinic. In one embodiment, an inventory module in the application is designed to specifically cater to how a dialysis clinic can most easily maintain and track its inventory. For example, if a clinic purchases a product that comes in a box containing multiple units, the inventor may require that the single box be counted as multiple units for the purpose of maintaining inventory in the clinic (e.g., one box containing 12 syringes). In another clinic, it may be more advantageous for inventory purposes to count the box rather than the number of products in the box. The present invention allows for the clinic to customize how the inventory will be counted, depending on the age of the clinic. A customizable inventory module allows the clinic to more effectively track inventory turns and the cost per treatment, important benchmarks for managing the clinic. The present system charts, graphs, and tracks purchases, on-hand inventory, open orders, and provides an historical database showing the purchase orders over the past several years. Moreover, by coordinating actual product deliveries with the receiving record, the opportunity for errors or over/under delivery is greatly reduced. The present system can be designed to only accept deliveries that match the purchase order and can require the entry of a specialized notice if the actual delivery does not match the associated purchase order.

The present invention also provides the vendors with the opportunity to be electronically integrated with the portal and accept purchase orders through the commerce portal. By establishing an account with the commerce portal, the vendors are able to provide product, pricing and delivery information for their goods, and allow the customers to shop through their products and purchase them online using their account. Where a vendor is not electronically integrated and does not have a specific account with the commerce portal, the vendor is still able to receive orders initially submitted to the commerce portal by a buyer and subsequently placed by the customer service department of the commerce portal.

Thus, as discussed herein, the embodiments of the present invention embrace systems and methods for providing a dynamically customizable commerce portal for the purchasing of goods and/or services that are offered for sale by a variety of vendors.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for providing a commerce portal that may be used to procure one or more products offered for sale by a variety of vendors, the system comprising:
a commerce portal, wherein the portal includes a customizable selection of products offered for sale by a variety of vendors;
a first computer device configured to provide information for the commerce portal;
a second computer device configured to selectively access the commerce portal to procure products provided in the commerce portal;
a network, wherein the first and second computer devices are connected to the network;
purchasing information representing products provided in the commerce portal that are to be purchased by a customer, wherein the second computer transmits the purchase information to the commerce portal; and
a third computer device connected to the network that is configured to track the purchasing of products from the portal by the customer.

2. A system as recited in claim 1, wherein the third computer device is at least one of:
(i) the first computer device; and
(ii) the second computer device.

3. A system as recited in claim 1, wherein the products offered for sale are medical products.

4. A system as recited in claim 3, wherein the medical products relate to performing a dialysis procedure.

5. A system as recited in claim 1, wherein a first product, of the products offered for sale, is from a first industry, and wherein a second product, of the products offered for sale is from a second industry.

6. A system as recited in claim 1, wherein the first computer device is a server.

7. A system as recited in claim 6, wherein the second computer device is a client.

8. A system as recited in claim 7, wherein the network is the Internet.

9. A system as recited in claim 1, wherein the products represented by the purchasing information are purchased electronically through the commerce portal.

10. A system as recited in claim 1, wherein the first computer is configured to selectively authorize access to the commerce portal.

11. A system as recited in claim 1, wherein the third computer is further configured to analyze information obtained by tracking the purchasing of products from the portal by the customer.

12. A system as recited in claim 11, wherein the third computer is configured to provide a report that includes information obtained by tracking the purchasing of products from the portal by the customer, wherein the report is provided to at least one of:
(i) the customer; and
(ii) a vendor.

13. In a system that includes a computer device and a network, a method for providing a commerce portal that may be used in the procurement of products from vendors, the method comprising the steps for:
providing a commerce portal that includes a customizable selection of products offered for sale by a variety of vendors;
receiving a purchasing order that indicates products provided in the commerce portal that are to be purchased by a customer;
distributing the purchasing order to one or more vendors;
monitoring information relating to purchasing of the products; and
tracking the purchases made of products from the portal by the customer.

14. A method as recited in claim 13, wherein the step for providing a commerce portal is performed by one or more servers.

15. A method as recited in claim 13, wherein the products offered for sale include products from a variety of different industries.

16. A method as recited in claim 13, wherein the products offered for sale include various medical products.

17. A method as recited in claim 13, further comprising the step for determining whether the purchasing order is authorized.

18. A method as recited in claim 13, further comprising the step for providing a purchase analysis to at least one of:
(i) the customer; and
(ii) at least one of the one or more vendors.

19. A computer program product for implementing within a computer system a method for providing a commerce portal that may be used in the procurement of products from vendors, the computer program product comprising
computer readable medium for providing computer program code means utilized to implement the method, wherein the computer program code means is comprised of executable code for implementing the steps for:
providing a commerce portal that includes a customizable selection of products offered for sale by a variety of vendors;
receiving a purchasing information that indicates products provided in the commerce portal that are to be purchased by a customer;
distributing the purchasing information to one or more vendors;
monitoring information relating to purchasing of the products included in the customizable selection of products; and
tracking the purchases made of products from the portal by the customer.

20. A computer program product as recited in claim 19, wherein the computer program code means is further comprised of executable code for implementing at least one of the steps for:
(i) authorizing the purchase information relating to the commerce portal; and
(ii) providing a purchase analysis.
